(19) United States
(12) Patent Application Publication
(10) Pub. No.: US 2014/0292632 A1
(43) Pub. Date: Oct. 2, 2014

(54) DISPLAY APPARATUS, DATA GAIN REGULATING CIRCUIT AND DATA GAIN REGULATING METHOD

(71) Applicant: Novatek Microelectronics Corp., Hsinchu (TW)

(72) Inventor: Hsing-Chuan Chen, Taichung City (TW)

(73) Assignee: Novatek Microelectronics Corp., Hsinchu (TW)

(21) Appl. No.: 14/071,659

(22) Filed: Nov. 5, 2013

Related U.S. Application Data
(60) Provisional application No. 61/807,334, filed on Apr. 2, 2013.

(30) Foreign Application Priority Data
Jul. 4, 2013 (TW) 102124049

(51) Int. Cl. G09G 3/34

(52) U.S. Cl. CPC G09G 3/3406
USPC 345/102

(57) ABSTRACT

A display apparatus, a data gain regulating circuit and a data gain regulating method are provided. The display apparatus includes a display module, a backlight module and the data gain regulating circuit. The backlight module provides backlight to the display module. The data gain regulating circuit is coupled to the display module and determines a gain value according to ambient light information and backlight information. The data gain regulating circuit regulates display data according to the gain value to obtain regulated display data and transmits the regulated display data to the display module.

### CROSS-REFERENCE TO RELATED APPLICATION

This application claims the priority benefits of U.S. provisional application Ser. No. 61/807,334, filed on Apr. 2, 2013 and Taiwan application serial no. 102124049, filed on Jul. 4, 2013. The entirety of each of the above-mentioned patent applications is hereby incorporated by reference herein and made a part of this specification.

### BACKGROUND

1. Technical Field

The invention relates to a display apparatus. Particularly, the invention relates to a data gain regulating circuit and a data gain regulating method of a display apparatus.

2. Related Art

Liquid crystal display (LCD) has become a mainstream in various display products due to its advantages of low operation voltage, no radiation, light weight and small size, etc. Along with popularisation of the LCD, many electronic products have a higher demand on a display function of the LCD, especially portable electronic products such as smart phones, personal digital assistants (PDAs), notebooks, tablet PCs, etc. These portable electronic products are not only required to have a good image display effect indoors, but also required to maintain good image quality outdoors or under a strong light environment. Therefore, how to maintain the good display quality of the LCD under the strong light environment is an important issue in technical development of the LCD.

In detail, the LCD is mainly composed of a backlight module and a display panel, since the display panel does not emit light itself, the backlight module is configured to provide a light source required by the LCD when displaying images. Generally, when a portable electronic product is used, as long as the portable electronic product is taken to a place with stronger sunlight, the display content on screen cannot be clearly viewed. A main reason thereof is that a luminance of the external sunlight is too strong, and the sunlight directly irradiating the screen is reflected by a surface of the screen, which results in a fact that the user cannot clearly view the convent displayed on the screen. An existing solution is to increase a backlight luminance of the display to improve visibility of the LCD under the strong light.

However, according to the above solution, the luminance of the backlight source of the display has to be maintained above a certain level, so as to avoid dullness due to over-bright of the ambient environment. However, the above solution is extremely power-consuming, and the user's eyes are probably uncomfortable due to over-bright of the screen. Moreover, when the portable electronic apparatus is used at a place with strong ambient environment light source, even if the luminance of the light source of the display is tuned to the maximum, presentation of image details is still not ideal. Therefore, in order to ensure that the images displayed on the screen of the portable electronic product can be clearly viewed under various environmental light source conditions (including indoor and outdoor environments), it is necessary to provide a novel display technique with a characteristic of strong light visibility.

### SUMMARY

Accordingly, the invention is directed to a display apparatus, a data gain regulating circuit and a data gain regulating method, which is capable of adjusting display content according to ambient light information and backlight information, so as to improve image display quality of a liquid crystal display (LCD).

The invention provides a display apparatus including a display module, a backlight module and a data gain regulating circuit. The backlight module provides a backlight to the display module. The data gain regulating circuit is coupled to the display module, and determines a gain value according to ambient light information and backlight information. The data gain regulating circuit regulates display data according to the gain value to obtain regulated display data, and transmits the regulated display data to the display module.

In an embodiment of the invention, besides according to the ambient light information and the backlight information, the data gain regulating circuit further determines the gain value according to the display data.

In an embodiment of the invention, the data gain regulating circuit first determines a “display data-gain relationship” according to the ambient light information and the backlight information, and obtains the gain value from the determined “display data-gain relationship” according to the display data.

In an embodiment of the invention, when the ambient light information indicates that the display apparatus is in a strong ambient light environment, the data gain regulating circuit correspondingly increases the gain value, and when the ambient light information indicates that the display apparatus is in a non-strong ambient light environment, the data gain regulating circuit correspondingly decreases the gain value.

In an embodiment of the invention, the data gain regulating circuit first converts an original backlight value represented by the backlight information to a target backlight value according to the backlight information and the ambient light information, and further regulates the gain value according to the ambient light information and the target backlight value.

In an embodiment of the invention, the data gain regulating circuit further provides a backlight control signal to the backlight module according to the target backlight value.

In an embodiment of the invention, the data gain regulating circuit first converts an original backlight value represented by the backlight information to a target backlight value according to the backlight information and the ambient light information, and provides a backlight control signal to the backlight module according to the target backlight value.

In an embodiment of the invention, the data gain regulating circuit is adapted to operate in at least one of following gain decision modes. In a first gain decision mode, the gain value is regulated according to an original backlight value represented by the backlight information and the ambient light information, where the original backlight value is non-related to the ambient light information. In a second gain decision mode, the original backlight value represented by the backlight information is first converted into a target backlight value according to the backlight information and the ambient light information, and the gain value is regulated according to the target backlight value and the ambient light information, where the target backlight value is related to the ambient light information.

In an embodiment of the invention, the data gain regulating circuit is adapted to operate in at least one of following backlight control modes. In a first backlight control mode, a backlight control signal is provided to the backlight module according to an original backlight value represented by the backlight information, where the backlight control signal is non-related to the ambient light information. In a second backlight control mode, an original backlight value represented by the backlight information is first converted into a target backlight value according to the backlight information and the ambient light information, and a backlight control signal is provided to the backlight module according to the target backlight value, where the backlight control signal is related to the ambient light information.

In an embodiment of the invention, the data gain regulating circuit determines an index value according to the backlight information and the ambient light information, and regulates the gain value according to the index value with reference of an index-gain curve.

In an embodiment of the invention, the data gain regulating circuit generates the index value according to an indoor luminance threshold.

In an embodiment of the invention, the index-gain curve is related to a γ characteristic parameter of a panel.

In an embodiment of the invention, the data gain regulating circuit obtains a first gain value with reference of the index-gain curve, and generates the gain value according to the display data and the first gain value.

In an embodiment of the invention, during a process that the data gain regulating circuit generates the gain value according to the display data and the first gain value, the data gain regulating circuit generates a third gain value to serve as the gain value according to the display data with reference of a data-gain curve, where the data-gain curve is generated according to the first gain value and a normalized data-gain curve.

In an embodiment of the invention, after the data gain regulating circuit obtains a first gain value, the data gain regulating circuit performs a smooth processing on the first gain value to generate a second gain value, and generates a third gain value to serve as the gain value according to the display data with reference of a data-gain curve, where the data-gain curve is generated according to the second gain value and a normalized data-gain curve.

The invention provides a data gain regulating circuit, adapted to a display apparatus. The data gain regulating circuit includes a gain decision circuit and a data regulating circuit. The gain decision circuit decides a gain value according to backlight information and ambient light information. The data regulating circuit is coupled to the gain decision circuit for receiving display data, and regulates the display data according to the gain value to obtain regulated display data.

In an embodiment of the invention, the data regulating circuit is implemented as a multiplication circuit.

In an embodiment of the invention, the gain decision circuit includes a curve index decision circuit and an index-gain conversion circuit. The curve index decision circuit decides an index value according to the backlight information and the ambient light information. The index-gain conversion circuit is coupled to the curve index decision circuit, and regulates a first gain value of the display data according to the index value with reference of an index-gain curve. The gain decision circuit regulates the gain value according to the first gain value.

In an embodiment of the invention, the curve index decision circuit determines the index value according to an indoor luminance threshold.

In an embodiment of the invention, the index-gain curve is related to a γ characteristic parameter of a panel.

In an embodiment of the invention, the gain decision circuit further includes a non-linear conversion circuit. The non-linear conversion circuit is coupled between the index-gain conversion circuit and the data regulating circuit, and the non-linear conversion circuit generates a third gain value to serve as the gain value according to the display data with reference of a data-gain curve, where the data-gain curve is generated according to the first gain value and a normalized data-gain curve.

In an embodiment of the invention, the gain decision circuit further includes a smooth circuit and a non-linear conversion circuit. The smooth circuit is coupled to the index-gain conversion circuit, and makes a variation of the first gain value to be smoother to generate a second gain value. The non-linear conversion circuit is coupled between the smooth circuit and the data regulating circuit, and the non-linear conversion circuit generates a third gain value to serve as the gain value according to the display data with reference of a data-gain curve, where the data-gain curve is generated according to the second gain value and a normalized data-gain curve.

In an embodiment of the invention, the data gain regulating circuit further includes a setting interface and an upper boundary decision circuit. The upper boundary decision circuit is coupled to the non-linear conversion circuit and the setting interface, and the upper boundary decision circuit controls the non-linear conversion circuit in accordance with the setting interface, so as to adjust a curve boundary of the third gain value.

In an embodiment of the invention, the data gain regulating circuit further includes a high dynamic range (HDR) engine and an upper boundary decision circuit. The upper boundary decision circuit is coupled to the non-linear conversion circuit and the HDR engine. The upper boundary decision circuit controls the non-linear conversion circuit according to an operation result of the HDR engine, so as to dynamically adjust a curve boundary of the third gain value.

In an embodiment of the invention, the data gain regulating circuit further includes at least one of a first debounce circuit, a second debounce circuit and a re-mapping circuit. The first debounce circuit receives the ambient light information and clamps the ambient light information to a first variation range. The second debounce circuit receives the backlight information and clamps the backlight information to a second variation range. The re-mapping circuit has a conversion relationship to re-map the ambient light information to a new ambient light value, and provides the new ambient light value to the gain decision circuit.

In an embodiment of the invention, the data gain regulating circuit further includes a backlight regulating circuit. The backlight regulating circuit is coupled to the gain decision circuit, and controls the gain decision circuit to correspondingly regulate the gain value of the display data according to the ambient light information and the backlight information.

In an embodiment of the invention, the backlight regulating circuit further outputs a backlight control signal according to the ambient light information and the backlight information, and the backlight control signal is configured to control a backlight module to dynamically regulate a backlight luminance

In an embodiment of the invention, the backlight regulating circuit includes a target backlight decision circuit. The target backlight decision circuit converts an original backlight value represented by the backlight information into a target backlight value according to the ambient light information and the backlight information, and the gain decision circuit regulates the gain value of the display data according to the target backlight value and the ambient light information.

In an embodiment of the invention, the backlight regulating circuit further includes at least one of a delay circuit and a smooth circuit coupled between the target backlight decision circuit and the gain decision circuit. The delay circuit is configured to delay a variation of the target backlight value. The smooth circuit is configured to smooth the variation of the target backlight value.

In an embodiment of the invention, the backlight regulating circuit further includes a setting interface. The setting interface is coupled to the target backlight decision circuit for providing a human-machine interface, so as to facilitate a user regulating the target backlight value of the target backlight decision circuit.

According to another aspect, the invention provides a data gain regulating method, which is adapted to a display apparatus. The data gain regulating method includes following steps. A gain value is determined according to backlight information and ambient light information. Display data is received, and the display data is regulated according to the gain value to obtain regulated display data.

According to the above descriptions, according to the display apparatus and the data gain regulating circuit and method thereof, the backlight information of the backlight module and the ambient light information of the display apparatus are combined to determine a gain value, and the gain value is used to adjust the display data. In this way, not only the display apparatus can normally work under a bright sunlight, the user in the strong light environment can also clearly and comfortably view image details presented by the display apparatus.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block schematic diagram of a display apparatus according to an embodiment of the invention.

FIG. 2 is a flowchart illustrating a data gain regulating method according to an embodiment of the invention.

FIG. 3 is a block schematic diagram of a display apparatus according to another embodiment of the invention.

FIG. 4 is a schematic diagram illustrating an input and output relationship of a debounce circuit according to an embodiment of the invention.

FIG. 5 is a schematic diagram illustrating an input and output relationship of a re-mapping circuit according to an embodiment of the invention.

FIG. 6 is a functional block diagram of a gain decision circuit according to an embodiment of the invention.

FIG. 7 is a schematic diagram illustrating a relationship between original data and regulated data according to an embodiment of the invention.

FIG. 8 is a schematic diagram of a GAMMA curve according to an embodiment of the invention.

FIG. 9 is a schematic diagram of a conversion curve of an index-gain conversion circuit according to an embodiment of the invention.

FIG. 10 is a waveform schematic diagram of an output signal of a smooth circuit according to an embodiment of the invention.

FIG. 11 is a waveform schematic diagram of an output signal of a smooth circuit according to an embodiment of the invention.

FIG. 12 is a waveform schematic diagram of an output signal of a smooth circuit according to an embodiment of the invention.

FIG. 13 is a waveform schematic diagram of an output signal of a smooth circuit according to an embodiment of the invention.

FIG. 14A is a schematic diagram of a normalized data-gain curve according to an embodiment of the invention.

FIG. 14B is a schematic diagram of a conversion curve of a non-linear conversion circuit according to an embodiment of the invention.

FIG. 15 is a block schematic diagram of a display apparatus according to an embodiment of the invention.

FIG. 16 is a block schematic diagram of a display apparatus according to an embodiment of the invention.

FIG. 17 is a functional block diagram of a backlight regulating circuit according to an embodiment of the invention.

FIG. 18 is a schematic diagram of a relationship between an ambient light output and a backlight output of a delay circuit according to an embodiment of the invention.

FIG. 19 is a functional block diagram of a display apparatus according to an embodiment of the invention.

### DETAILED DESCRIPTION OF DISCLOSED EMBODIMENTS

A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. Moreover, wherever possible, components/members/steps using the same referential numbers in the drawings and description refer to the same or like parts. Components/members/steps using the same referential numbers or using the same terms in different embodiments may cross-refer related descriptions.

In a part of the following embodiments, a data gain can be adaptively regulated according to different ambient light luminance and backlight information, such that display content can be clearly presented under a strong light. Moreover, in the other part of the following embodiments, backlight luminance can be first regulated according to the ambient light luminance and the backlight information, and the data gain is correspondingly regulated according to the regulated backlight luminance. In the other embodiments, the two embodiments can be combined to implement different operation modes.

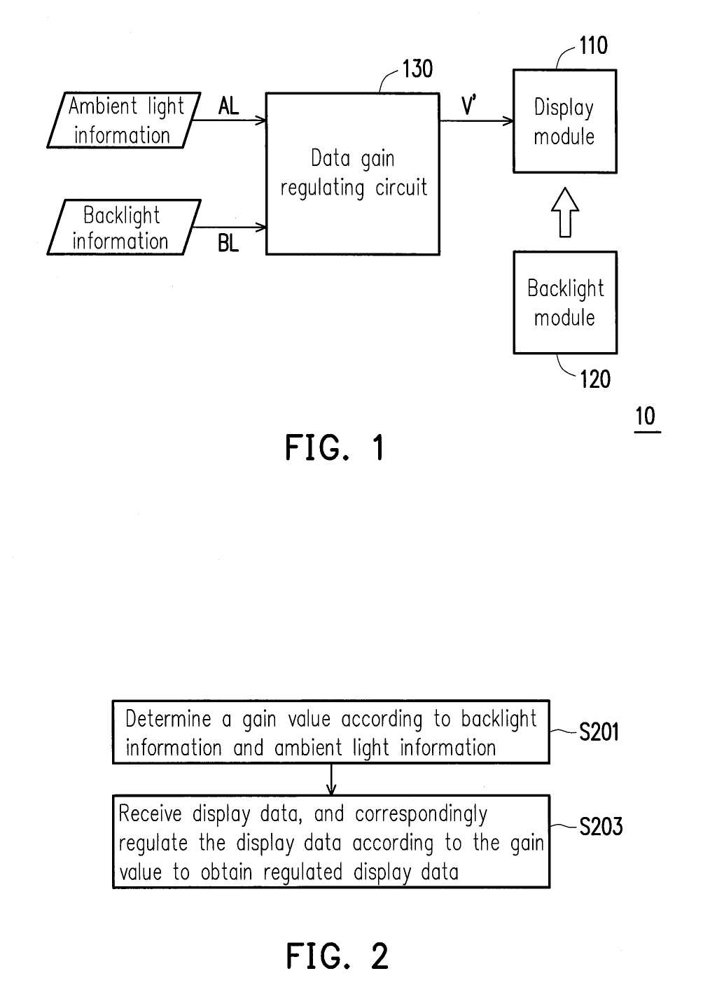

FIG. 1 is a block schematic diagram of a display apparatus according to an embodiment of the invention. Referring to FIG. 1, the display apparatus 10 is, for example, a liquid crystal display (LCD), which includes a display module 110, a backlight module 120 and a data gain regulating circuit 130. In some embodiments, the display module 110 may include a display panel, a scalar, a timing controller, a source driver and/or a gate driver, etc. The display module 110 is coupled to the data gain regulating circuit 130 for receiving regulated display data V′. The display module 110 drives the display panel according to the display data V′ of an image. The backlight module 120 is configured to provide a backlight source to the display panel of the display module 110. In the present embodiment, the backlight module 120 may control the luminance of the backlight source according to a pulse width modulation (PWM) signal. Moreover, according to a light incident manner of the backlight source, the backlight module 120 can be a direct type or an edge type backlight module, which is not limited by the invention.

The data gain regulating circuit 130 is an integrated circuit with a computation function, and the data gain regulating circuit 130 is coupled to the display module 110. The data gain regulating circuit 130 of the invention may adaptively adjust the data gain according to different ambient light information AL and backlight information BL. Further, the data gain regulating circuit 130 receives the ambient light information AL, the backlight information BL and the display data V. The backlight information BL is related to the backlight luminance of the backlight module 120, and the ambient light information AL is related to luminance of an environment where the display apparatus 10 locates. In some embodiments, the display apparatus 10 is configured with an optical sensor for sensing the luminance of the environment where the display apparatus 10 locates. The optical sensor is, for example, a photo-diode, a phototransistor, a photoresistor, or other devices capable of generating a photo current or a sensing signal after receiving light irradiation. In brief, the ambient light information AL is related to the sensing signal of the photo sensor.

Another embodiment is provided below to further describe the invention, FIG. 2 is a flowchart illustrating a data gain regulating method according to an embodiment of the invention. Referring to FIG. 1 and FIG. 2, the method of the present embodiment is adapted to the aforementioned display apparatus 10, detailed steps of the data gain regulating method of the present embodiment are described below with reference of various components of the display apparatus 10.

In step S201, the data gain regulating circuit 130 of the display apparatus 10 determines a gain value according to the ambient light information AL and the backlight information BL. In other words, the gain value is a parameter obtained according to the ambient light information AL and the backlight information BL, so that the display apparatus 10 can adaptively adjust the data gain value according to different ambient light luminance. Then, in step S203, the data gain regulating circuit 130 receives the display data V, and correspondingly regulates the display data V according to the gain value to obtain the regulated display data V′. Thereafter, the data gain regulating circuit 130 transmits the regulated display data V′ to the display module 110. Namely, the display apparatus 10 can adaptively adjust the display data V according to the ambient environment, so that the display module 110 can clearly display image frames to the user according to the regulated display data V′ under various environments.

For example, when the ambient light information AL indicates that the display apparatus 10 is in a strong ambient light environment, the data gain regulating circuit 130 correspondingly increases the gain value, and the user can easily view image details presented by the display module 110 of the display apparatus 10. When the ambient light information AL indicates that the display apparatus 10 is in a non-strong ambient light environment, the data gain regulating circuit 130 correspondingly decreases the gain value. For example, when the display apparatus 10 is located in an indoor environment with a suitable light source, since the user can already clearly view the whole image frame, the data gain regulating circuit 130 is unnecessary to adjust the display data V. Now, the data gain regulating circuit 130 can regulate the gain value to 1, i.e. the content of the display data V is not changed.

It should be noticed that in some other embodiments, besides according to the ambient light information AL and the backlight information BL, the data gain regulating circuit 130 can further determine the gain value according to the display data V. In other words, for example, the data gain regulating circuit 130 first determines a “display data-gain relationship” according to the ambient light information AL and the backlight information BL, and then obtains the gain value from the determined “display data-gain relationship” according to the display data V. For example, the “display data-gain relationship” can be represented by a “display data-gain relationship curve”. Therefore, the data gain regulating circuit 130 can obtain the corresponding gain value from the determined “display data-gain relationship curve” according to the display data V, though the invention is not limited thereto.

Therefore, the data gain regulating circuit 130 of the display apparatus 10 can adaptively determine the gain value G according to the ambient light information AL, the backlight information BL and the display data V, and produces the regulated display data suitable for various environments according to the gain value G. In order to further describe how the data gain circuit obtains the gain value and regulates the display data, an embodiment is provided below for detailed descriptions.

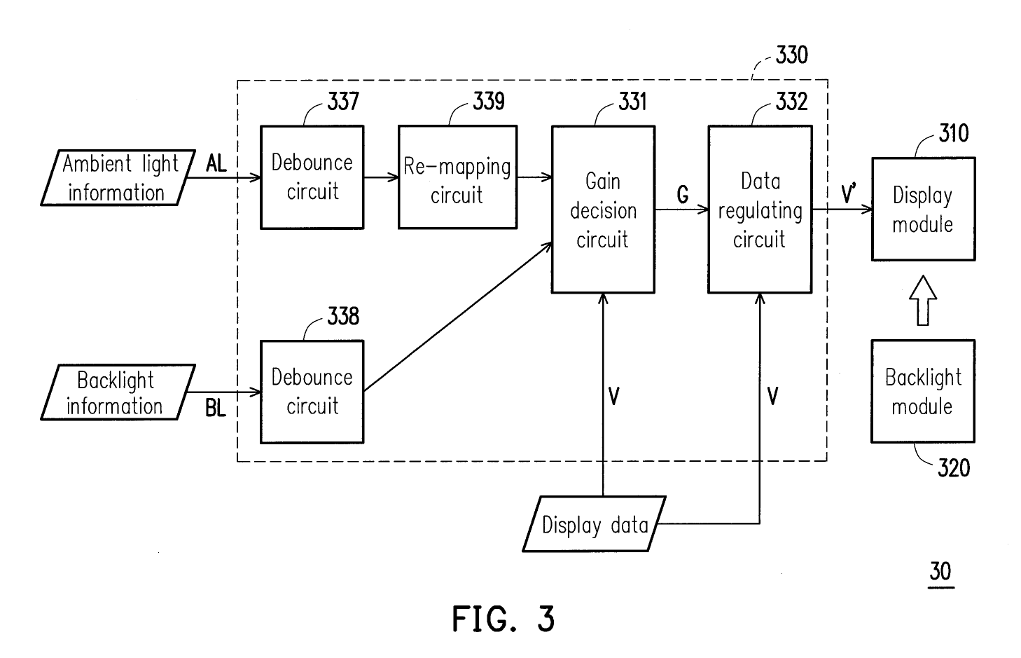

FIG. 3 is a block schematic diagram of a display apparatus according to another embodiment of the invention. Referring to FIG. 3, the display apparatus 30 includes a display module 310, a backlight module 320 and a data gain regulating circuit 330. The display module 310 and the backlight module 320 are similar to the display module 110 and the backlight module 120 of FIG. 1, so that details thereof are not repeated. In the present embodiment, the data gain regulating circuit 330 includes a gain decision circuit 331 and a data regulating circuit 332. In brief, the gain decision circuit 331 decides the gain value G according to the backlight information BL and the ambient light information AL. The data regulating circuit 332 is coupled to the gain decision circuit 331. The data regulating circuit 332 receives the display data V, and correspondingly regulates the display data V according to the gain value G to obtain the regulated display data V′. It should be noticed that in the present embodiment, the data regulating circuit 332 can be implemented as a multiplication circuit. When the data regulating circuit 332 implemented as the multiplication circuit obtains the gain value G, the data regulating circuit 332 multiplies the original display data V by the corresponding gain value G to obtain the regulated display data V′, so as to achieve an effect of regulating the display data V, though the invention is not limited thereto.

According to the above descriptions, it is known that the gain decision circuit 331 can obtain the gain value G directly according to the backlight information BL and the ambient light information AL. Moreover, in some embodiments, besides the backlight information BL and the ambient light information AL, the gain decision circuit 331 can also determine the “display data-gain relationship” according to the display data V, where the “display data-gain relationship” can be, for example, represented by a “display data-gain relationship curve” or a lookup table. In this way, the gain decision circuit 331 can obtain the corresponding gain value G from the determined “display data-gain relationship curve” according to the original display data V, and transmits the gain value G to the data regulating circuit 332. Therefore, the gain decision circuit 331 can establish a relationship between the display data V and the gain value G, such that the gain decision circuit 331 can find the corresponding gain value G according to the display data V. However, the operation method of the gain decision circuit 331 is not limited by the invention.

In the present embodiment, the gain decision circuit 331 calculates a function related to the backlight information BL and the ambient light information AL to obtain the corresponding gain value G. For example, the gain decision circuit 110 can calculate a function shown in a following equation (1) to obtain the gain value G, where BL_{full} is backlight information of a full backlight source (for example, a duty ratio of the backlight source is 100%), AL is the ambient light information, and BL is the backlight information.

$$G = f ( \frac{{BL}_{full}}{BL \times \frac{IL}{AL}} ) \qquad ( 1 )$$

It should be noticed that in the equation (1), IL is defined as an indoor luminance threshold. The indoor luminance threshold defines a boundary of an indoor luminance range that the user can comfortably view the screen. The indoor luminance threshold can be adjusted according to an actual application requirement. In general, when the ambient light luminance of the environment where the display apparatus 30 locates exceeds the indoor luminance threshold, the display apparatus 30 is regarded to be located in a strong light environment. BL_{full} can be a maximum grayscale of pixel in the display data. For example, if the display data V is a 8-bit data, since the display data V may present grayscales 0-255, the maximum grayscale is 255. However, the function shown in the equation (1) is only an exemplary implementation, and the invention is not limited thereto. Thereafter, the data regulating circuit 332 can calculate a multiplication of the display data V and the gain value G to obtain new display data, i.e. the regulated display data V′. The data regulating circuit 332 transmits the new display data V′ to the display module 310, and the display module 310 displays the regulated display data V′ provided by the data regulating circuit 332.

Moreover, as that shown in FIG. 3, it is discovered that the data gain regulating circuit 330 may further include a debounce circuit 337, a debounce circuit 338 and a re-mapping circuit 339. The debounce circuit 337 receives the ambient light information AL and clamps the ambient light information AL to a first variation range. The debounce circuit 338 receives the backlight information BL and clamps the backlight information BL to a second variation range. Moreover, the re-mapping circuit 339 has a conversion relationship to re-map the ambient light information AL to a new ambient light value, and provides the new ambient light value to the gain decision circuit 331.

Moreover, it should be noticed that although implementation of the present embodiment is as that shown in FIG. 3, the present embodiment can be modified according to an actual application requirement and design requirement. For example, one or more of the debounce circuit 337, the debounce circuit 338 and the re-mapping circuit 339 of the data gain regulating 330 can be omitted. Fore example, in some embodiments, the re-mapping circuit 339 can be omitted. In some other embodiments, the debounce circuit 337, the debounce circuit 338 and the re-mapping circuit 339 can all be omitted to directly supply the ambient light information AL and the backlight information BL to the gain decision circuit 331.

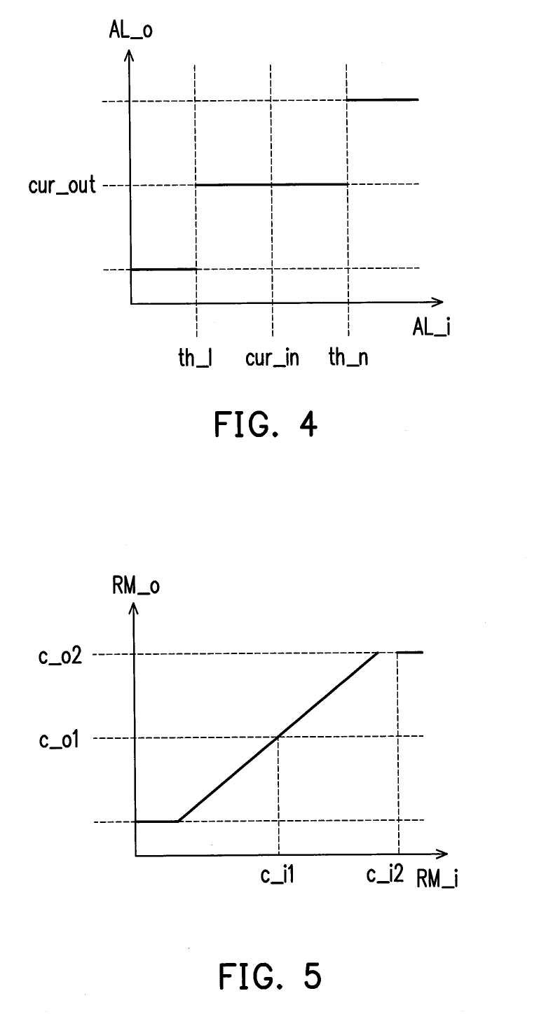

According to the above descriptions, it is known that the ambient light information AL is related to the sensing signal of the photo sensor. Therefore, the sensing signals of different types of the photo sensors have different sensing error ranges. Moreover, a single photo sensor may measure different luminance values in a same luminance environment due to various factors. In order to resolve such problem, the debounce circuit 337 is used to clamp the ambient light information to an acceptable variation range. In detail, FIG. 4 is a schematic diagram illustrating an input and output relationship of a debounce circuit according to an embodiment of the invention. Referring to FIG. 4, a horizontal axis of FIG. 4 represents an input AL_i of the debounce circuit 337, and a vertical axis represents an output AL_o of the debounce circuit 337. According to FIG. 4, it is known that the debounce circuit 337 may convert an input luminance value of a certain specific range th_{—}1-th_n into a fixed output luminance value. For example, as that shown in FIG. 4, when the debounce circuit 337 receives the ambient light information with the luminance value of cur_in, the debounce circuit 337 outputs the ambient light information with the luminance value of cur_out. Therefore, by using the debounce circuit 337, the ambient light information AL received by the gain decision circuit 331 is not constantly varied due to the error of the photo sensor, so as to improve stability of the circuit. Implementation method of the debounce circuit 337 is not limited by the invention, in some embodiments, the debounce circuit 337 can be a delay circuit. Deduced by analogy, the debounce circuit 338 can also clamp the backlight information BL to an acceptable variation range.

On the other hand, the re-mapping circuit 339 has a conversion relationship to re-map the ambient light information AL output by the debounce circuit 337 to a new ambient light value, such that the gain value G decided by the gain decision circuit 331 can be different gain values G according to an actual application requirement or a specific situation. For example, FIG. 5 is a schematic diagram illustrating an input and output relationship of a re-mapping circuit according to an embodiment of the invention. Referring to FIG. 5, a horizontal axis of FIG. 5 represents an input RM_i of the re-mapping circuit 339, and a vertical axis represents an output RM_o of the re-mapping circuit 339. As that shown in FIG. 5, if the input of the re-mapping circuit 339 is c_i1, the output of the re-mapping circuit 339 is c_o1. If the input of the re-mapping circuit 339 is c_i2, the output of the re-mapping circuit 339 is c_o2. It should be noticed that the aforementioned conversion relationship can be defined according to a design requirement or a customized requirement. For example, a slope of an oblique line corresponding to the input and output of the re-mapping circuit 339 can be set according to different situations, so as to satisfy the actual application requirements.

As that shown in FIG. 3, in the present embodiment, the gain decision circuit 331 determines a “display data-gain relationship curve” according to the backlight information output by the debounce circuit 338 and the new ambient light value output by the re-mapping circuit 339. Therefore, the gain decision circuit 331 can further obtain the corresponding gain value G from the determined “display data-gain relationship curve” according to the original display data V.

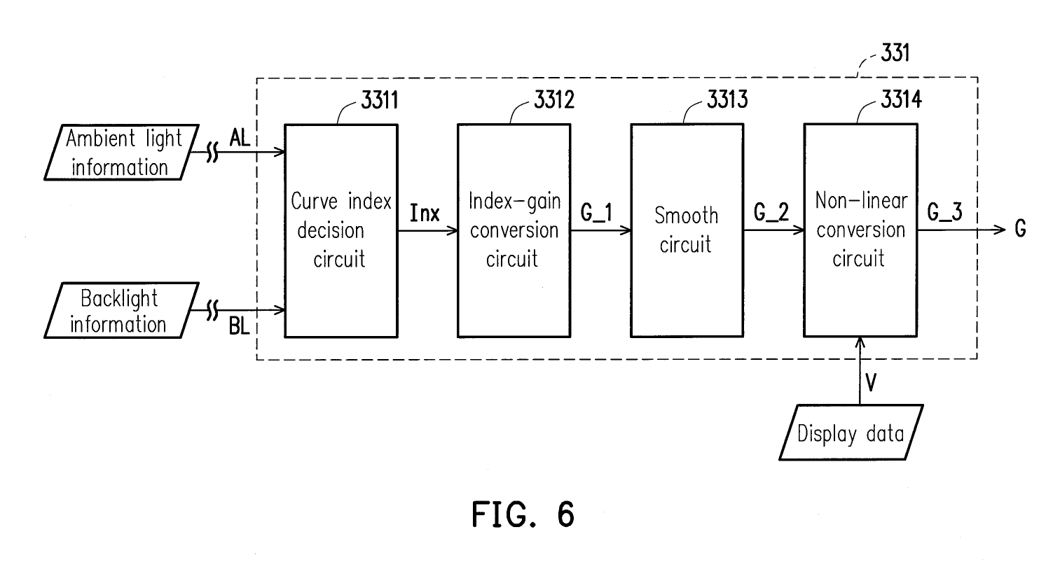

FIG. 6 is a functional block diagram of the gain decision circuit 331 of FIG. 3. Referring to FIG. 3 and FIG. 6, the gain decision circuit 331 includes a curve index decision circuit 3311, an index-gain conversion circuit 3312, a smooth circuit 3313 and a non-linear conversion circuit 3314. The curve index decision circuit 3311 decides an index value Inx according to the backlight information BL and the ambient light information AL. The index-gain conversion circuit 3312 is coupled to the curve index decision circuit 3311, and regulates a first gain value G_{—}1 of the display data according to the index value Inx with reference of an “index-gain curve”, where the gain decision circuit 331 regulates the gain value G according to the first gain value G_{—}1. It should be noticed that the content of the embodiment of FIG. 6 can be varied according to an actual application requirement and a design requirement. For example, the gain decision circuit 331 may only include the curve index decision circuit 3311 and the index-gain conversion circuit 3312, and the first gain value G_{—}1 output by the index-gain conversion circuit 3312 can be directly taken as the gain value G. Namely, any one of or both of the smooth circuit 3313 and the non-linear conversion circuit 3314 can be removed from the gain decision circuit 331, which is not limited by the invention.

In the present embodiment, the curve index decision circuit 3311 can calculate/decide the index value Inx of the gain according to a relationship between the backlight information BL and the ambient light information AL, and outputs the index value Inx to the index-gain conversion circuit 3312. The calculation method of the curve index decision circuit 3311 is not limited by the invention. In the present embodiment, the curve index decision circuit 3311 may calculate a function related to the backlight information BL and the ambient light information AL to obtain the index value Inx. For example, the curve index decision circuit 3311 may obtain the index value Inx according to a function shown in a following equation (2). Where, Inx is the index value of the gain, IL is an indoor luminance threshold, AL is the ambient light information, and BL is the backlight information. According to the equation (2), it is known that the curve index decision circuit 3311 can further determine the index value Inx according to the indoor luminance threshold IL.

$$Inx = \frac{IL}{AL} \times BL \qquad ( 2 )$$

According to descriptions of the equation (1) and the equation (2), the index-gain curve of the present embodiment may present a relationship shown in a following equation (3):

$$G = f ( \frac{{BL}_{full}}{BL \times \frac{IL}{AL}} ) = f ( \frac{{BL}_{full}}{Inx} ) \qquad ( 3 )$$

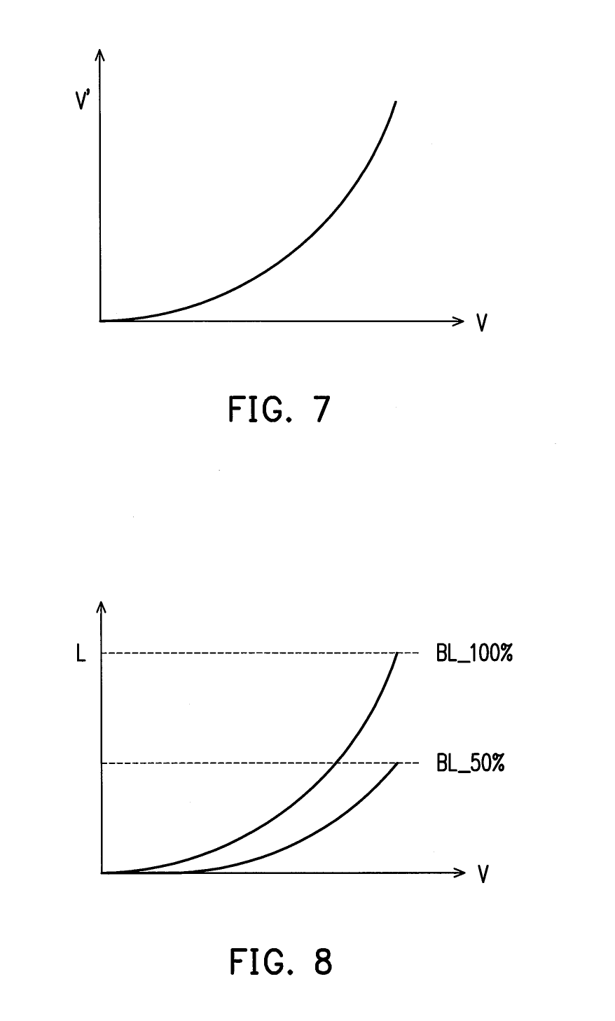

Although the index-gain curve is as that shown in the equation (3), the invention does not limit a conversion relationship between the ambient light information AL, the backlight information BL and the index value Inx, and a corresponding relationship between the index value Inx and the gain value G can be implemented by a lookup table (LUT), though the invention is not limited thereto. For example, in some other embodiments, a form of the function ƒ in the equation (1) or the equation (3) can be determined according to a GAMMA parameter γ related to a characteristic of the display panel of the display module 310. Therefore, the gain value G can be obtained according to the function shown in the equation (1) or the equation (3). FIG. 7 is a schematic diagram illustrating a relationship between original data and regulated data according to an embodiment of the invention. In detail, a horizontal axis of FIG. 7 represents original display data V, and a vertical axis represents display data V′ output to the display module 310 by the data regulating circuit 332. Referring to FIG. 7, since human eyes have different feelings for different grayscales (luminance), the GAMMA curve defines the relationship between the original display data V and the display data V′ regulated through the GAMMA parameter γ in allusion to the feelings of human eyes.

Moreover, FIG. 8 is a schematic diagram of a GAMMA curve according to an embodiment of the invention. In FIG. 8, a horizontal axis represents the original display data V, and a vertical axis represents a display luminance L of the display module 310. Where, the luminance

$$L = BL \times {( \frac{V}{maximum grayscale} )}^{γ} .$$

According to FIG. 8, it is clear that by controlling the backlight luminance provided by the backlight module (i.e. regulates the backlight information BL), the GAMMA curve is also different. Therefore, based on an assumption that the original display data V presents a luminance the same with that of the original backlight value under the new backlight value, an equation (4) is obtained, and an equation (5) is accordingly deduced. Where, G is the gain value, IL is the indoor luminance threshold, AL is the ambient light information, BL is the backlight information, BL_{full} is the backlight information under a full backlight source, V′ is the display data output to the display module 310 by the data regulating circuit 332, V is the original display data, and γ is GAMMA parameter related to a characteristic of the display panel of the display module 310. Therefore, if the form of the function ƒ in the equation (1) or the equation (3) is determined according to the GAMMA parameter γ of the display panel, the index-gain curve is related to the GAMMA parameter γ of the display panel.

$$\begin{matrix}{BL}_{full} \times {( \frac{V}{BL} )}^{γ} = ( BL \times \frac{IL}{AL} ) \times {( \frac{{V}^{′}}{BL} )}^{γ} & ( 4 ) \\ G = f ( \frac{{BL}_{full}}{BL \times \frac{IL}{AL}} ) = {10}^{\frac{lo g ( {BL}_{full} / BL \times \frac{IL}{AL} )}{γ}} & ( 5 )\end{matrix}$$

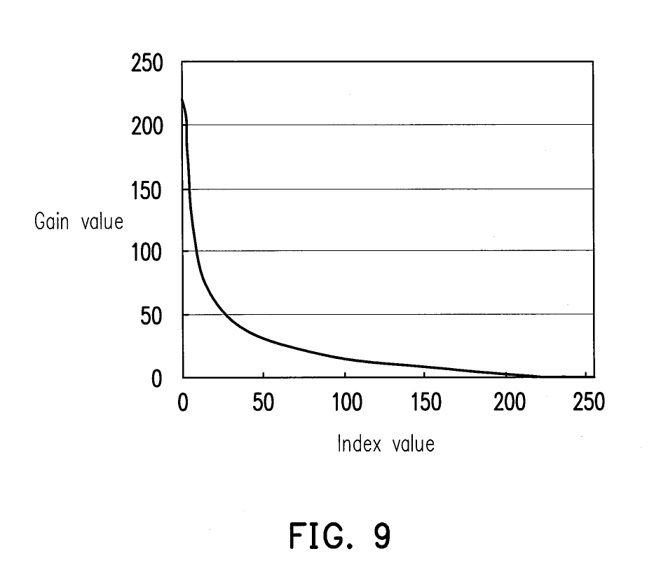

According to the index value Inx, the index-gain conversion circuit 3312 can calculate/decide the first gain value G_{—}1 of the display data V, and outputs the first gain value G_{—}1 to the smooth circuit 3313. In the present embodiment, the index-gain conversion circuit 3312 can find the corresponding first gain value G_{—}1 from the “index-gain conversion curve” according to the index value Inx of the gain. Therefore, the invention does not limit the conversion method adopted by the index-gain conversion circuit 3312. For example, FIG. 9 is a schematic diagram of a conversion curve of the index-gain conversion circuit 3312 shown in FIG. 6 according to an embodiment of the invention, in which a horizontal axis represents the index value Inx, and a vertical axis represents an output signal (i.e. the first gain value G_{—}1) of the index-gain conversion circuit 3312. The index-gain conversion circuit 3312 can find the corresponding first gain value G_{—}1 from the conversion curve shown in FIG. 9 according to the index value Inx output by the curve index decision circuit 3311.

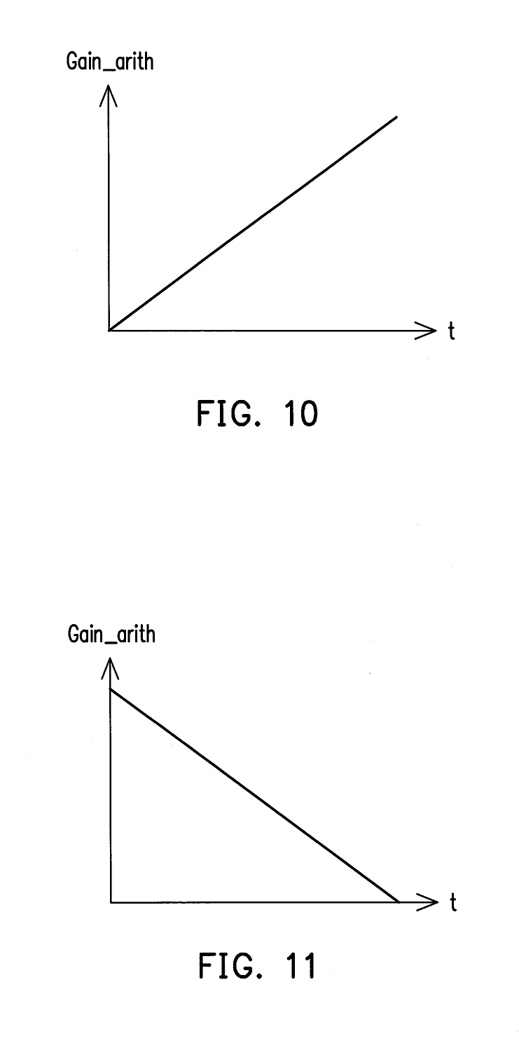

Referring to FIG. 6, the gain decision circuit 331 further includes the smooth circuit 3313 and the non-linear conversion circuit 3314. The smooth circuit 3313 is coupled to the index-gain conversion circuit 3312. The smooth circuit 3313 makes a variation of the first gain value G_{—}1 to be smoother to generate the second gain value G_{—}2. However, a smooth method adopted by the smooth circuit 3313 is not limited by the invention. The smooth circuit 3313 may adopt an arithmetical smooth method, for example, an arithmetic means. FIG. 10 and FIG. 11 are waveform schematic diagrams of an output signal of the smooth circuit 3313 according to an embodiment of the invention, in which a horizontal axis represent time t, and a vertical axis represents an output signal Gain_arith of the smooth circuit 3313. Referring to FIG. 10, during a rising edge of the input signal of the smooth circuit 3313, the waveform of the output signal of the smooth circuit 3313 presents an arithmetic increment. Referring to FIG. 11, during a falling edge of the input signal of the smooth circuit 3313, the waveform of the output signal of the smooth circuit 3313 presents an arithmetic decrement.

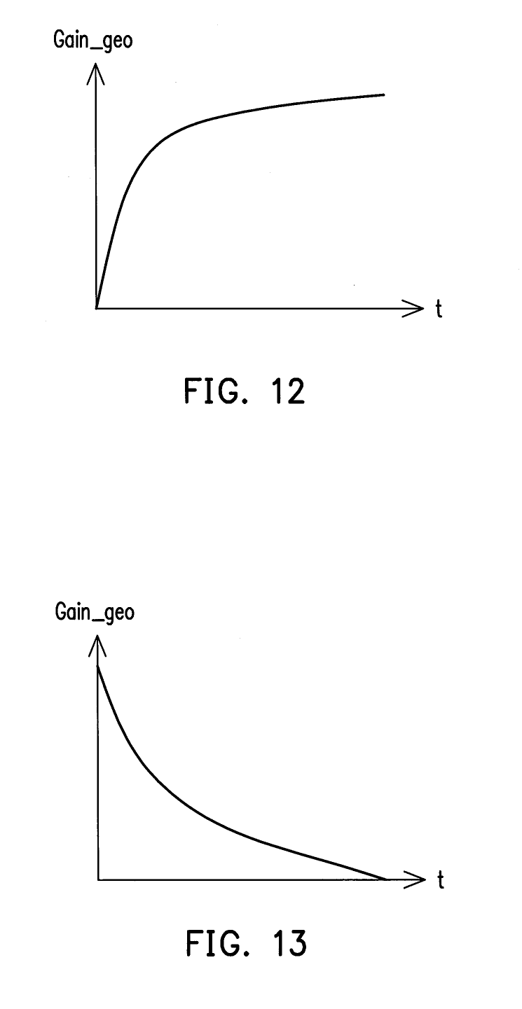

Moreover, the smooth circuit 3313 may also adopt a geometrical smooth method, for example, a geometric means. FIG. 12 and FIG. 13 are waveform schematic diagrams of an output signal of the smooth circuit 3313 according to an embodiment of the invention, in which a horizontal axis represent time t, and a vertical axis represents an output signal Gain_geo of the smooth circuit 3313. Referring to FIG. 12, during a rising edge of the input signal of the smooth circuit 3313, the waveform of the output signal of the smooth circuit 3313 presents a geometric increment. Referring to FIG. 13, during a falling edge of the input signal of the smooth circuit 3313, the waveform of the output signal of the smooth circuit 3313 presents a geometric decrement. Regardless the type of the smooth method, the smooth circuit ensures a smooth variation of the gain value, such that the display apparatus 30 can change the luminance of the display data in a smooth way, and the user can comfortably view the displayed images.

On the other hand, the non-linear conversion circuit 3314 is coupled between the smooth circuit 3313 and the data regulating circuit 332, and the non-linear conversion circuit 3314 generates a third gain value G_{—}3 to serve as the gain value G according to the display data V with reference of a data-gain curve, where the data-gain curve is generated according to the second gain value G_{—}2 and a normalized data-gain curve. In detail, the non-linear conversion circuit 3314 converts the second gain value G_{—}2 output by the smooth circuit 3313 into the third gain value G_{—}3 by using a non-linear approach, and outputs the third gain value G_{—}3 to the data regulating circuit 332. However, the conversion method adopted by the non-linear conversion circuit 3314 is not limited by the invention.

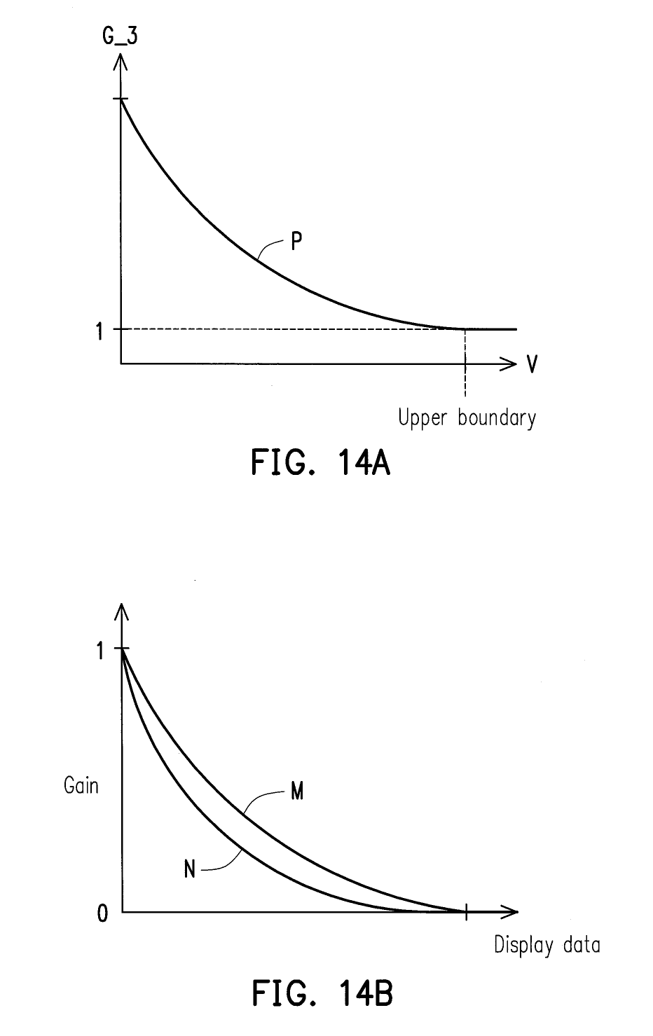

For example, FIG. 14B is a schematic diagram of a normalized data-gain curve according to an embodiment of the invention, in which a horizontal axis represents the original display data V, and a vertical axis represents the gain value G_{—}3 of the non-linear conversion circuit 3314. As that shown in FIG. 14B, different LUTs can be used to represent a plurality of different normalized data-gain curves. Different normalized data-gain curves can be obtained through different LUTs, for example, a curve M or a curve N shown in FIG. 14B, and the normalized data-gain curves can be determined according to an actual application requirement. Generally, the normalized data-gain curve is as that shown in FIG. 14B, which is a concave curve, so as to avoid a phenomenon of reverse curving of the relationship between the original display data V and the regulated display data V′.

FIG. 14A is a schematic diagram of a conversion curve of a non-linear conversion circuit according to an embodiment of the invention, in which a horizontal axis represents the original display data V, and a vertical axis represents the gain value G_{—}3 of the non-linear conversion circuit 3314. In detail, the normalized data-gain curve M or N shown in FIG. 14B is multiplied by the second gain value G_{—}2 output by the smooth circuit 3313, and then a multiplication result is added by 1 to generate the data-gain curve P shown in FIG. 14A.

According to FIG. 14A, it is known that when the original display data V is greater than a curve boundary (or an upper boundary), the third gain value G_{—}3 output by the non-linear conversion circuit 3314 is maintained to 1. Therefore, the non-linear conversion circuit 114 may avoid a saturation/distortion problem of the display frame. In detail, when the data regulating circuit 332 multiplies the display data V by the gain value G, the saturation/distortion problem is probably occurred. This is because that when a part of display data with higher original luminance in the image frame is multiplied by the gain value G, the luminance values of this part of display data are all regulated to the same maximum luminance value, which leads to the saturation/distortion problem of the image frame. Therefore, as that shown in FIG. 14A, the non-linear conversion circuit 3314 determines the corresponding third gain value G_{—}3 according to the display data V to serve as the gain value G output by the gain decision circuit 331. The third gain value G_{—}3 corresponding to the display data V with a luminance value between the upper boundary and the maximum grayscale approaches to 1. Namely, the display data with the luminance value greater than the upper boundary is maintained to the original luminance value, i.e. the display data with high luminance value is not changed.

It should be noticed that in the present embodiment, the first gain value G_{—}1 generated by the index-gain conversion circuit 3312 and the second gain value G_{—}2 generated by the smooth circuit are all global gain values, and the third gain value G_{—}3 output by the non-linear conversion circuit 3314 I a local gain value. In brief, the gain decision circuit 331 of the present embodiment first determines the global first gain value G_{—}1 and second gain value G_{—}2 according to the backlight information BL and the ambient light information AL. Then, the gain decision circuit 331 determines the local third gain value G_{—}3 according to the display data V. In brief, the third gain value G_{—}3 is changed along with variation of the content of the display data V, and the first gain value G_{—}1 and the second gain value G_{—}2 are not changed along with variation of the content of the display data V.

Namely, in other embodiment, if the non-linear conversion circuit 3314 does not exist, the data regulating circuit 332 can use the global gain values only to adjust the content of the display data V in overall. Namely, the display apparatus 30 only generates the global gain values according to the backlight information BL and the ambient light information AL. In brief, the gain values of the display data V are all the same, and the gain values are not changed along with variation of the display data.

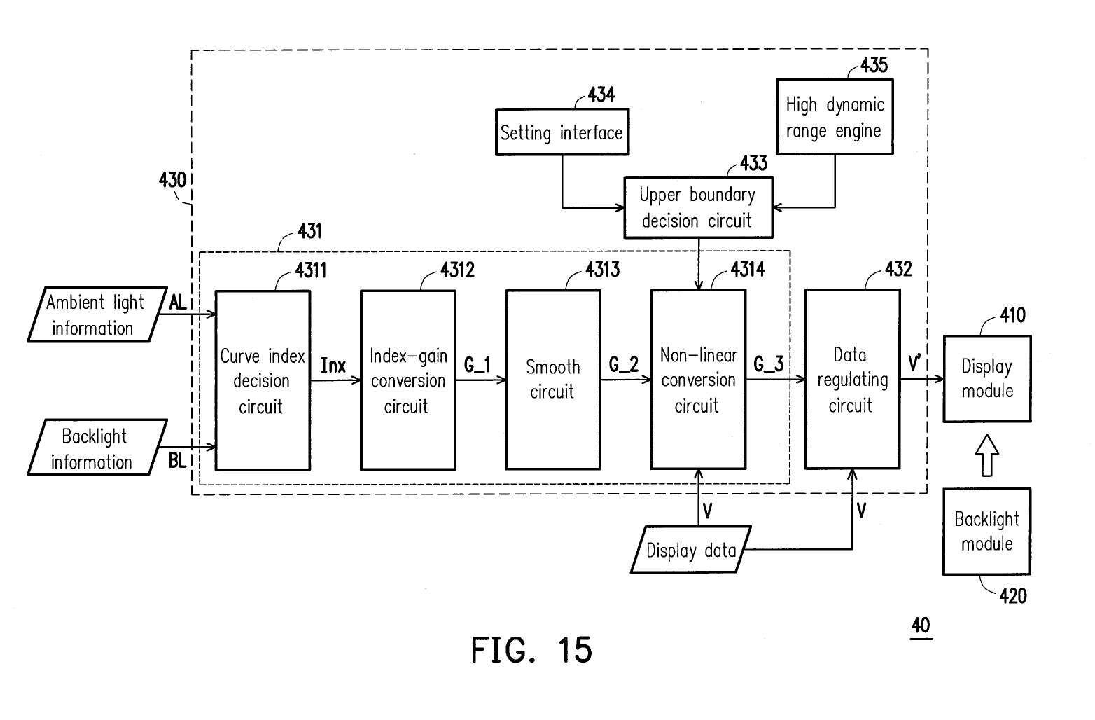

FIG. 15 is a block schematic diagram of a display apparatus according to still another embodiment of the invention. Referring to FIG. 15, the display apparatus 40 includes a display module 410, a backlight module 420 and a data gain regulating circuit 430. The display module 410 and the backlight module 420 are similar to the display module 110 and the backlight module 120 of FIG. 1, so that details thereof are not repeated. The embodiment of FIG. 15 can be deduced according to related descriptions of FIG. 1 or FIG. 3. Different to the display apparatus 30 of FIG. 3, the data gain regulating circuit 430 of the display apparatus 40 of FIG. 15 does not have a debounce circuit and a re-mapping circuit, and the gain decision circuit 431 directly receives the ambient light information AL and the backlight information BL. Moreover, a curve index decision circuit 4311, an index-gain conversion circuit 4312, a smooth circuit 4313 and a non-linear conversion circuit 4314 in internal of the gain decision circuit 431 and a data regulating circuit 432 may refer to related descriptions of the curve index decision circuit 3311, the index-gain conversion circuit 3312, the smooth circuit 3313 and the non-linear conversion circuit 3314 in internal of the gain decision circuit 331 of FIG. 6 and the data regulating circuit 332 of FIG. 3, and details thereof are not repeated.

It should be noticed that different to the embodiment of FIG. 3, the display apparatus 40 of the present embodiment further has an upper boundary decision circuit 433, a setting interface 434 and a high dynamic range (HDR) engine 435. The upper boundary decision circuit 433 is coupled to the non-linear conversion circuit 4314 and the setting interface 434, and the upper boundary decision circuit 433 controls the non-linear conversion circuit 4314 according to the setting interface 434, so as to adjust a curve boundary of the third gain G_{—}3, for example, adjust the upper boundary of FIG. 14B. Moreover, the upper boundary decision circuit 433 is further coupled to the HDR engine 435. The upper boundary decision circuit 433 controls the non-linear conversion circuit 4314 according to an operation result of the HDR engine 435, so as to dynamically adjust a curve boundary of the third gain value G_{—}3, for example, adjust the upper boundary of FIG. 14B. The HDR engine 435 can be implemented by a conventional HDR engine or other circuit with the similar function, which is not limited by the invention.

According to the related description of FIG. 14B, it is known that the non-linear conversion circuit 4314 can maintain the display data V with the luminance value higher than the upper boundary to an original state (since now the gain value G is 1). In the present embodiment, the setting interface 434 provides a human-machine interface to facilitate the user adjusting/changing the upper boundary shown in FIG. 14B. In other words, the upper boundary decision circuit 433 can control the non-linear conversion circuit 4314 according to the setting interface 434, so as to adjust the upper boundary shown in FIG. 14B. Moreover, the upper boundary decision circuit 433 can also control the non-linear conversion circuit 4314 according to an operation result of the HDR engine 435, so as to dynamically adjust the upper boundary shown in FIG. 14B, which is not limited by the invention.

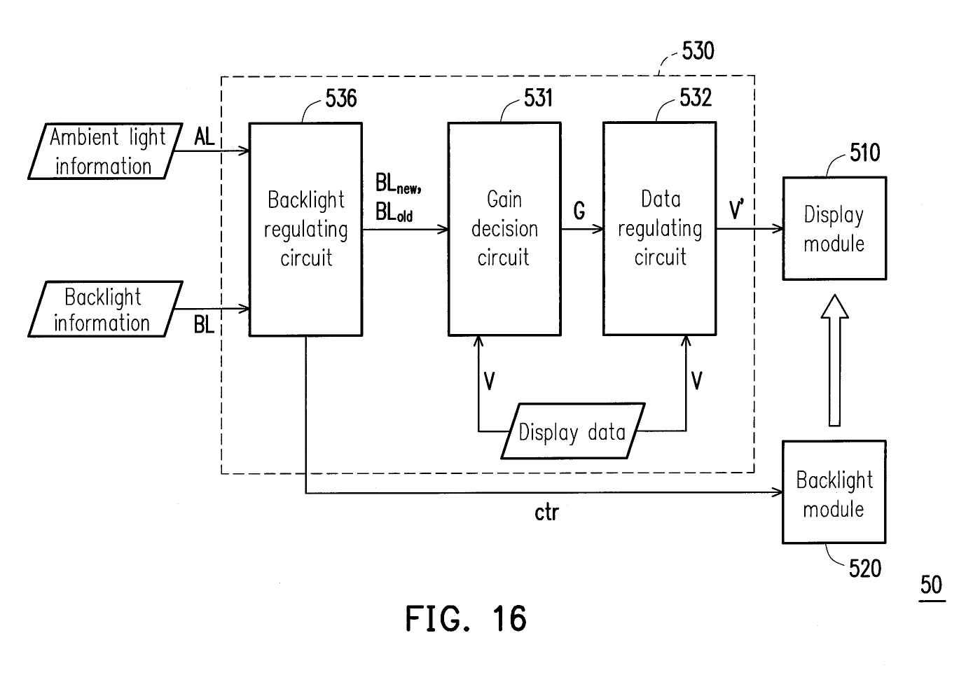

FIG. 16 is a block schematic diagram of a display apparatus according to yet another embodiment of the invention. Referring to FIG. 16, the display apparatus 50 includes a display module 510, a backlight module 520 and a data gain regulating circuit 530. The display module 510 and the backlight module 520 are similar to the display module 110 and the backlight module 120 of FIG. 1, so that details thereof are not repeated. The embodiment of FIG. 16 can be deduced according to related descriptions of FIG. 1 or FIG. 3. Different to the display apparatus 30 of FIG. 3, the data gain regulating circuit 530 of the display apparatus 50 of FIG. 16 does not have a debounce circuit and a re-mapping circuit. Moreover, the gain decision circuit 531 and the data regulating circuit 532 of FIG. 16 are similar to the gain decision circuit 331 and the data regulating circuit 332 of FIG. 3, and operation methods and functions thereof can be deduced according to related descriptions of the gain decision circuit 331 and the data regulating circuit 332 of FIG. 3.

Different to the embodiment of FIG. 3, the embodiment of FIG. 16 further includes a backlight regulating circuit 536. Referring to FIG. 16, the backlight regulating circuit 536 is coupled to the gain decision circuit 531, and controls the gain decision circuit 531 to correspondingly regulate the gain value G of the display data V according to the ambient light information AL and the backlight information BL. The backlight regulating circuit 536 further outputs a backlight control signal ctr to the backlight module 520 according to the ambient light information AL and the backlight information BL. The backlight control signal ctr is used for controlling the backlight module 520 to dynamically regulate a backlight luminance.

The data gain regulating circuit 530 may operate in at least one of a first gain decision mode and a second gain decision mode. When the data gain regulating circuit 530 operates in the first gain decision mode, the backlight regulating circuit 536 provides an original backlight value BL_{old} represented by the backlight information BL and the ambient light information AL to the gain decision circuit 531, such that the gain decision circuit 531 regulates the gain value G according to the original backlight value BL_{old} and the ambient light information AL, where the original backlight value BL_{old} is non-related to the ambient light information AL. When the data gain regulating circuit 530 operates in the second gain decision mode, the backlight regulating circuit 536 converts the original backlight value BL_{old} represented by the backlight information BL into a target backlight value BL_{new} according to the backlight information BL and the ambient light information AL, and provides the target backlight value BL_{new} and the ambient light information AL to the gain decision circuit 531, such that the gain decision circuit 531 regulates the gain value G according to the target backlight value BL_{new} and the ambient light information AL, where the target backlight value BL_{new} is related to the ambient light information AL.

Moreover, the data gain regulating circuit 530 can operate in at least one of a first backlight control mode and a second backlight control mode. When the data gain regulating circuit 530 operates in the first backlight control mode, the backlight regulating circuit 536 provides the backlight control signal ctr to the backlight module 520 according to an original backlight value BL_{old} represented by the backlight information, where the backlight control signal ctr is non-related to the ambient light information AL. When the data gain regulating circuit 530 operates in the second backlight control mode, the backlight regulating circuit 536 converts the original backlight value BL_{old} represented by the backlight information BL into the target backlight value BL_{new} according to the backlight information BL and the ambient light information AL, and provides the backlight control signal ctr to the backlight module 520 according to the target backlight value BL_{new}, where the backlight control signal ctr is related to the ambient light information AL.

In detail, in the first backlight mode of the backlight regulating circuit 536, i.e. under the premise that the data gain regulating circuit 530 does not regulate the backlight luminance of the backlight module 520 according to the ambient light information AL, the backlight control signal ctr is non-related to the ambient light information AL. The backlight regulating circuit 536 can control the gain decision circuit 531 according to the ambient light information AL and/or the backlight information BL, so as to correspondingly adjust the gain value G of the display data V. For example, when the electronic apparatus is operated in a strong ambient light (for example, sunlight), the backlight regulating circuit 536 can control the gain decision circuit 531 according to the ambient light information AL and the backlight information BL, so as to correspondingly adjust the gain value G of the display data V.

Under the strong ambient light, the higher the gain value G of the display data V is, the easier the user views image details presented by the display module 510. Therefore, under the premise that the backlight luminance of the backlight module 520 is not regulated, the backlight regulating circuit 536 can control the gain decision circuit 531 according to the ambient light information AL and/or the backlight information BL, so as to correspondingly adjust the gain value G of the display data V. For example, the backlight regulating circuit 536 can define an indoor luminance threshold in advance. When the ambient light information AL is greater than the indoor luminance threshold, it is known that the electronic apparatus is under the strong ambient light, and the backlight regulating circuit 536 can control the gain decision circuit 531 according to the ambient light information AL and the backlight information BL, so as to correspondingly increase the gain value G of the display data V.

On the other hand, when the backlight regulating circuit 536 is in the second backlight mode, the backlight regulating circuit 536 can control the backlight module 520 according to the ambient light information BL and the backlight information AL, so as to correspondingly regulate the backlight luminance. Namely, the backlight control signal ctr output by the backlight regulating circuit 536 is related to the ambient light information AL. Further, the backlight regulating circuit 536 can control the gain decision circuit 531 to correspondingly regulate the gain value G of the display data V in collaboration with regulation of the backlight luminance. For example, the backlight regulating circuit 536 can correspondingly increase the gain value G of the display data V in collaboration with increase of the backlight luminance, such that the user can view image details presented by the display module 510 under the strong ambient light. In detail, under the strong ambient light, the brighter the luminance of the backlight provided by the backlight module 520 is, the easier the user views the image frame presented by the display module 510. However, in some applications, even if the luminance of the backlight is regulated to the highest, the image details presented by the display module 510 are still not clear. Therefore, the backlight regulating circuit 536 can control the gain decision circuit 531 to correspondingly regulate the gain value G of the display data V in collaboration with regulation of the backlight luminance

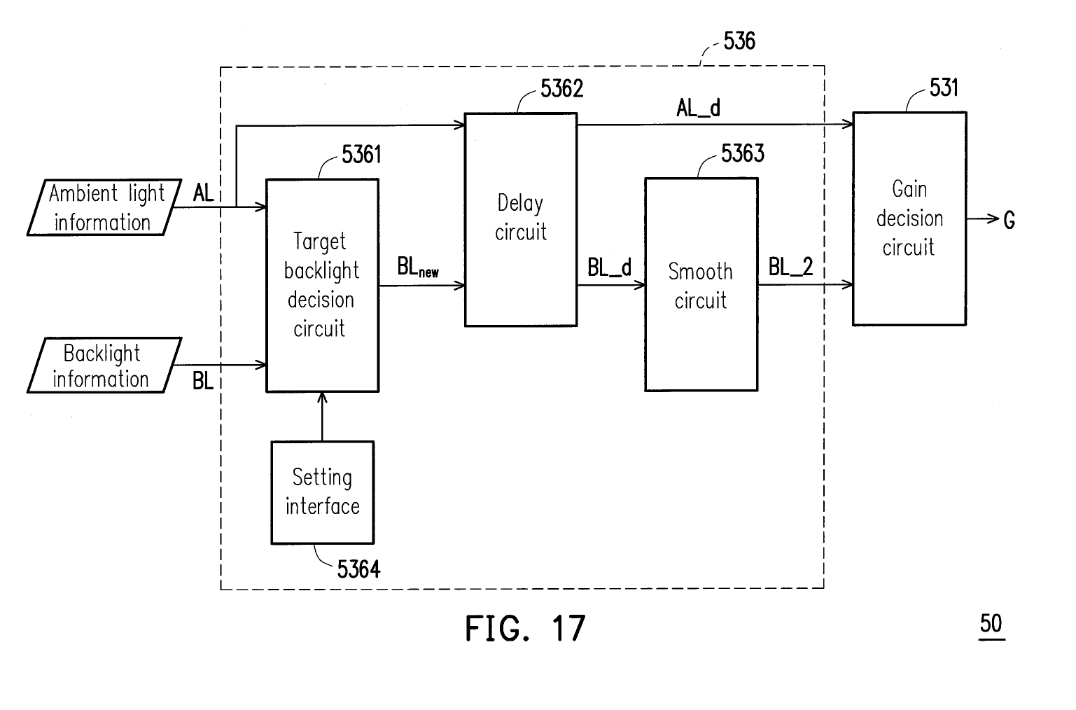

FIG. 17 is a functional block diagram of a backlight regulating circuit 536 of FIG. 16. Referring to FIG. 16 and FIG. 17, the backlight regulating circuit 536 includes a target backlight decision circuit 5361, a delay circuit 5362, a smooth circuit 5363 and a setting interface 5364. Although implementation of the present embodiment is as that shown in FIG. 17, according to an actual application status and design requirement, the embodiment can be modified. For example, one of the delay circuit 5362 and the smooth circuit 5363 in the backlight regulating circuit 536 can be omitted. For example, in some embodiments, the smooth circuit 5363 can be removed. In some other embodiments, both of the delay circuit 5362 and the smooth circuit 5363 can be omitted, and the target backlight value BL_{new} output by the target backlight decision circuit 5361 and the ambient light information AL are directly supplied to the gain decision circuit 531. Therefore, the target backlight decision circuit 5361 converts the original backlight value BL_{old} represented by the backlight information BL into the target backlight value BL_{new} according to the ambient light information AL and the backlight information BL, and the gain decision circuit 531 regulates the gain value G of the display data V according to the target backlight value BL_{new} and the ambient light information AL.

In detail, the target decision circuit 5361 determines the target backlight value BL_{new} according to the ambient light information AL and the backlight information BL. However, the operation method adopted by the target backlight decision circuit 5361 is not limited by the invention. In the present embodiment, the target backlight decision circuit 5361 can calculate a function related to the backlight information BL and the ambient light information A1 to obtain the target backlight value BL_{new}. For example, the target backlight decision circuit 5361 can obtain the target backlight value BL_{new} according to the calculation function shown in a following equation (6). Where, BL_{new} is the target backlight value, IL is the indoor luminance threshold, AL is the ambient light information, BL_{old} is the original backlight value in the backlight information BL, k is a parameter determined according to a design requirement.

$${BL}_{new} = \frac{AL}{IL} \times {BL}_{old} \times k \qquad ( 6 )$$

According to the equation (6), it is known that when the indoor luminance threshold IL is rather close to the ambient light information AL, it represents that the target backlight decision circuit 5361 is in an environment with moderate luminance. Therefore, there is not much difference between the target backlight value BL_{new} and the original backlight value BL_{old} in the backlight information BL.

The delay circuit 5362 is coupled between the target backlight decision circuit 5361 and the smooth circuit 5363. The delay circuit 5362 is configured to avoid too frequent signal transition. In detail, when the ambient light is transited from bright to dark, the delay circuit 5362 can delay a period of time, for example, several seconds or tens of seconds to implement the signal transition. In the present embodiment, the delay circuit 5362 is configured to delay a variation of the target backlight value BL_{new}. In this way, a situation that a transient repeat variation of the ambient light information influences control of the backlight regulating circuit 536 on the gain decision circuit 531 and the backlight module 520 is avoided, such that the display device is not flickering due to the negligible transient repeat variation of the ambient light information.

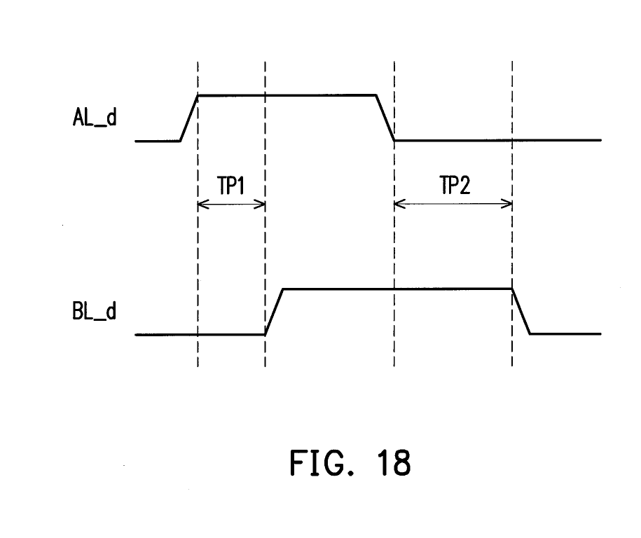

FIG. 18 is a schematic diagram of a relationship between an ambient light output and a backlight output of the delay circuit 5362 according to an embodiment of the invention. In FIG. 18, a horizontal axis represents time. When the ambient light output AL_d of the delay circuit 5362 is transited from dark to bright, and is maintained to a bright state, the backlight output BL_d is delayed by a time period TP1 before transition. For example, when the ambient light output AL_d is transited from dark to bright, the backlight output BL_d is delayed by one second before it is transited from dark to bright. Moreover, when the ambient light output AL_d is transited from bright to dark, the backlight output BL_d is delayed by a time period TP2 before transition. In the present embodiment, the time period TP2 is set to be greater than the time period TP1, for example, the time period TP2 is 10 seconds, and the time period TP1 is 2 seconds. The delay circuit 5362 transmits the ambient light output AL_d to the gain decision circuit 531, and transmits the backlight output BL_d to the smooth circuit 5363.

The smooth circuit 5363 is configured to smooth the variation of the target backlight value BL_{new}, which smoothes a signal variation to output a second target backlight value BL_{—}2 to the gain decision circuit 531. The smooth method adopted by the smooth circuit 1420 is not limited by the invention. The function and operation of the smooth circuit 5363 are similar to that of the smooth circuit 3313 of FIG. 6, and the smooth circuit 5363 can adopt an arithmetical or geometrical smooth method to smooth the signal variation. Referring to detailed descriptions of FIG. 10 to FIG. 13, which are not repeated. According to the backlight value BL_{—}2 output by the smooth circuit 5363, and according to the relationship between the indoor luminance threshold IL and the ambient light information BL, the gain decision circuit 531 can calculate/decide the gain value G of the display data V. Therefore, when the display apparatus 50 is in the strong ambient light (for example, the sunlight), the backlight regulating circuit 536 can control the gain decision circuit 531 according to the ambient light information AL and the backlight information BL, so as to correspondingly regulate the gain value G of the display data V.

The setting interface 5364 is coupled to the target backlight decision circuit 5361 to provide a human-machine interface, so as to facilitate the user regulating the target backlight value BL_{new} of the target backlight decision circuit 5361. For example, the user can regulate the target backlight value BL_{new} by adjusting the parameter k in the equation (6).

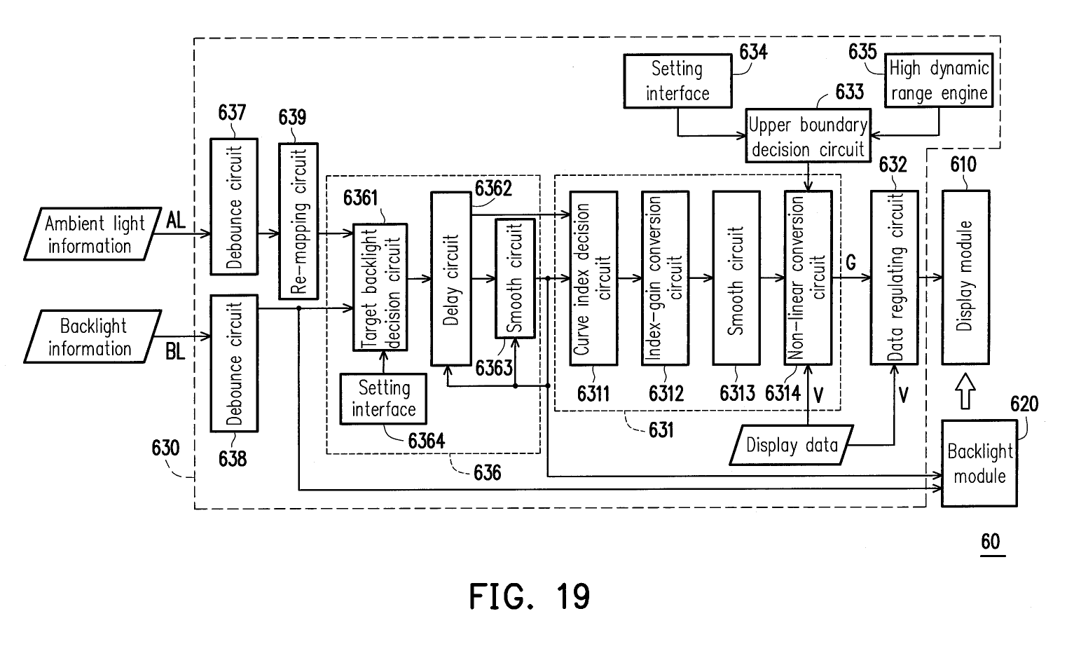

FIG. 19 is a functional block diagram of a display apparatus 60 according to an embodiment of the invention. Referring to FIG. 19, the display apparatus 60 includes a display module 610, a backlight module 620 and a data gain regulating circuit 630. The display module 610 and the backlight module 620 are similar to the display module 110 and the backlight module 120 of FIG. 1, so that details thereof are not repeated. The data gain regulating circuit 630 includes a gain decision circuit 631, a data regulating circuit 632, an upper boundary decision circuit 633, a setting interface 634, a high dynamic range (HDR) engine 635, a backlight regulating circuit 636, a debounce circuit 637, a debounce circuit 638 and a re-mapping circuit 639.

Operation methods and functions of the debounce circuit 637, the debounce circuit 638 and a re-mapping circuit 639 are similar to the debounce circuit 337, the debounce circuit 338 and a re-mapping circuit 339 of FIG. 3, and details thereof can refer to the related description of FIG. 3, which are not repeated. A difference between the present embodiment and the embodiment of FIG. 3 is that the re-mapping circuit 639 and the debounce circuit 638 of the present embodiment are coupled to the backlight regulating circuit 636. The debounce circuit 638 can clamp the backlight information BL to an acceptable variation range, and provides the clamped backlight information to the backlight regulating circuit 636. The re-mapping circuit 639 has a conversion relationship to re-map the ambient light information output by the debounce circuit 638 to a new ambient light value, and provides the new ambient light value to the backlight regulating circuit 636.

In the present embodiment, the backlight regulating circuit 636 is coupled to the gain decision circuit 631. The backlight regulating circuit 636 includes a target backlight decision circuit 6361, a delay circuit 6362, a smooth circuit 6363 and a setting interface 6364. The gain decision circuit 631 includes a curve index decision circuit 6311, an index-gain conversion circuit 6312, a smooth circuit 6313 and a non-linear conversion circuit 6314. Detailed descriptions of the gain decision circuit 631 and the data regulating circuit 632 can refer to relation descriptions of the gain decision circuit 331 and the data regulating circuit 332 in FIG. 3 and FIG. 6. Detailed description of the backlight regulating circuit 636 can refer to related description of the backlight regulating circuit 536 in FIG. 17, which is not repeated.

According to the above descriptions, it is known that the data gain regulating circuit of the invention may operate in the first gain decision mode and the second gain decision mode according to a gain deciding method. Moreover, the data gain regulating circuit of the invention may operate in the first backlight control mode and the second backlight control mode according to a backlight regulating method. In the present embodiment, the display apparatus 60 shown in FIG. 19 has at least two operation modes of a first operation mode and a second operation mode. When the display apparatus 60 is in the first operation mode, i.e. the data gain regulating circuit 630 is in the first gain decision mode and the first backlight control mode, the data gain regulating circuit 630 dynamically regulates the gain value G of the display data V according to the ambient light information AL and the backlight information BL without regulating the backlight luminance of the backlight module 620. Namely, the display apparatus 60 dynamically regulates the gain value G of the display data V according to the ambient light information AL and the backlight information BL without regulating the backlight luminance.

In detail, in the first operation mode, the target backlight decision circuit 6361 and the smooth circuit 6363 can be disabled. Now, the backlight module 620 determines the backlight luminance according to the original backlight information BL. In case that the target backlight decision circuit 6361 and the smooth circuit 6363 are disabled, the curve index decision circuit 6311 calculates/determines the index value Inx of the gain value according to a relationship between the original backlight information BL and the ambient light information AL provided by the delay circuit 6362, and outputs the index value Inx to the index-gain conversion circuit 6312. Therefore, under a premise of not regulating the backlight luminance of the backlight module 140, the gain decision circuit 110 can correspondingly regulate the gain value G of the display data V in the first operation mode according to the ambient light information AL and the backlight information BL. Under the strong ambient light (for example, the sunlight), the higher the gain value G of the display data V is, the easier the user views image details presented by the display module 130.

When the display apparatus 60 is in the second operation mode, i.e. the data gain regulating circuit 630 is in the second gain decision mode and the second backlight control mode, the display apparatus 60 regulates the gain value G of the display data V and the luminance of the backlight module 610. In the second operation mode, the target backlight decision circuit 6361 and the smooth circuit 6363 can be enabled. Now, the target backlight decision circuit 6361 can determine the target backlight value BL_{new} in the second operation mode according to the ambient light information AL and the backlight information BL, and controls the backlight module 620 through the delay circuit 6362 and the smooth circuit 6363, so as to correspondingly regulate the backlight luminance. Besides, the gain decision circuit 631 can correspondingly regulate the gain value G of the display data V in the second operation mode according to the backlight value (related to the target backlight value BL_{new}) output by the smooth circuit 6363 and the ambient light information AL provided by the delay circuit 6362. For example, the backlight regulating circuit 636 can correspondingly control the gain decision circuit 631 to increase the gain value G of the display data V in collaboration with increase of the backlight luminance, such that the user can view the image details presented by the display module 610 in the strong ambient light.

In summary, besides that the data gain regulating circuit of the invention can regulate the gain value of the display data according to the ambient light information and the backlight information, the data gain regulating circuit can further regulate the gain value of the display data according to the display data itself. Therefore, the display apparatus can adaptively regulate the gain value of the display data according to the environment where the display apparatus locates, or in collaboration with regulation of the backlight module, the display apparatus can even flexibly regulate the display image of the display data. In this way, the display apparatus of the invention may have the characteristic of strong light visibility under various ambient light conditions, such that even if the user is in the strong light environment, the user can still clearly and comfortably view the image details.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display apparatus, comprising:
a display module;
a backlight module, providing a backlight to the display module; and
a data gain regulating circuit, coupled to the display module, determining a gain value according to ambient light information and backlight information, regulating display data according to the gain value to obtain regulated display data, and transmitting the regulated display data to the display module.

2. The display apparatus as claimed in claim 1, wherein besides according to the ambient light information and the backlight information, the data gain regulating circuit further determines the gain value according to the display data.

3. The display apparatus as claimed in claim 2, wherein the data gain regulating circuit first determines a “display data-gain relationship” according to the ambient light information and the backlight information, and obtains the gain value from the determined “display data-gain relationship” according to the display data.

4. The display apparatus as claimed in claim 1, wherein when the ambient light information indicates that the display apparatus is in a strong ambient light environment, the data gain regulating circuit correspondingly increases the gain value;
and when the ambient light information indicates that the display apparatus is in a non-strong ambient light environment, the data gain regulating circuit correspondingly decreases the gain value.

5. The display apparatus as claimed in claim 1, wherein the data gain regulating circuit first converts an original backlight value represented by the backlight information to a target backlight value according to the backlight information and the ambient light information, and further regulates the gain value according to the ambient light information and the target backlight value.

6. The display apparatus as claimed in claim 5, wherein the data gain regulating circuit further provides a backlight control signal to the backlight module according to the target backlight value.

7. The display apparatus as claimed in claim 1, wherein the data gain regulating circuit first converts an original backlight value represented by the backlight information to a target backlight value according to the backlight information and the ambient light information, and provides a backlight control signal to the backlight module according to the target backlight value.

8. The display apparatus as claimed in claim 1, wherein the data gain regulating circuit is adapted to operate in at least one of following gain decision modes:
a first gain decision mode: the gain value is regulated according to an original backlight value represented by the backlight information and the ambient light information, wherein the original backlight value is non-related to the ambient light information; and
a second gain decision mode: the original backlight value represented by the backlight information is first converted into a target backlight value according to the backlight information and the ambient light information, and the gain value is regulated according to the target backlight value and the ambient light information, wherein the target backlight value is related to the ambient light information.

9. The display apparatus as claimed in claim 1, wherein the data gain regulating circuit is adapted to operate in at least one of following backlight control modes:
a first backlight control mode: a backlight control signal is provided to the backlight module according to an original backlight value represented by the backlight information, wherein the backlight control signal is non-related to the ambient light information; and
a second backlight control mode: an original backlight value represented by the backlight information is first converted into a target backlight value according to the backlight information and the ambient light information, and a backlight control signal is provided to the backlight module according to the target backlight value, wherein the backlight control signal is related to the ambient light information.

10. The display apparatus as claimed in claim 1, wherein the data gain regulating circuit determines an index value according to the backlight information and the ambient light information, and regulates the gain value according to the index value with reference of an index-gain curve.

11. The display apparatus as claimed in claim 10, wherein the data gain regulating circuit generates the index value according to an indoor luminance threshold.

12. The display apparatus as claimed in claim 10, wherein the index-gain curve is related to a γ characteristic parameter of a panel.

13. The display apparatus as claimed in claim 10, wherein the data gain regulating circuit obtains a first gain value with reference of the index-gain curve, and generates the gain value according to the display data and the first gain value.

14. The display apparatus as claimed in claim 13, wherein during a process that the data gain regulating circuit generates the gain value according to the display data and the first gain value, the data gain regulating circuit generates a third gain value to serve as the gain value according to the display data with reference of a data-gain curve, wherein the data-gain curve is generated according to the first gain value and a normalized data-gain curve.

15. The display apparatus as claimed in claim 13, wherein after the data gain regulating circuit obtains a first gain value, the data gain regulating circuit performs a smooth processing on the first gain value to generate a second gain value, and generates a third gain value to serve as the gain value according to the display data with reference of a data-gain curve, wherein the data-gain curve is generated according to the second gain value and a normalized data-gain curve.

16. A data gain regulating circuit, adapted to a display apparatus, comprising:
a gain decision circuit, deciding a gain value according to backlight information and ambient light information; and
a data regulating circuit, coupled to the gain decision circuit, receiving display data, and regulating the display data according to the gain value to obtain regulated display data.

17. The data gain regulating circuit as claimed in claim 16, wherein besides according to the ambient light information and the backlight information, the data gain regulating circuit further determines the gain value according to the display data.

18. The data gain regulating circuit as claimed in claim 17, wherein the data gain regulating circuit first determines a “display data-gain relationship” according to the ambient light information and the backlight information, and obtains the gain value from the determined “display data-gain relationship” according to the display data.

19. The data gain regulating circuit as claimed in claim 16, wherein the data regulating circuit is implemented as a multiplication circuit.

20. The data gain regulating circuit as claimed in claim 16, wherein the gain decision circuit comprises:
a curve index decision circuit, deciding an index value according to the backlight information and the ambient light information; and
an index-gain conversion circuit, coupled to the curve index decision circuit, and regulating a first gain value of the display data according to the index value with reference of an index-gain curve,
wherein the gain decision circuit regulates the gain value according to the first gain value.

21. The data gain regulating circuit as claimed in claim 20, wherein the curve index decision circuit determines the index value according to an indoor luminance threshold.

22. The data gain regulating circuit as claimed in claim 20, wherein the index-gain curve is related to a γ characteristic parameter of a panel.

23. The data gain regulating circuit as claimed in claim 20, wherein the gain decision circuit further comprises:
a non-linear conversion circuit, coupled between the index-gain conversion circuit and the data regulating circuit, and generating a third gain value to serve as the gain value according to the display data with reference of a data-gain curve, wherein the data-gain curve is generated according to the first gain value and a normalized data-gain curve.

24. The data gain regulating circuit as claimed in claim 20, wherein the gain decision circuit further comprises:
a smooth circuit, coupled to the index-gain conversion circuit, and making a variation of the first gain value to be more smooth to generate a second gain value; and
a non-linear conversion circuit, coupled between the smooth circuit and the data regulating circuit, and generating a third gain value to serve as the gain value according to the display data with reference of a data-gain curve, wherein the data-gain curve is generated according to the second gain value and a normalized data-gain curve.

25. The data gain regulating circuit as claimed in claim 23, further comprising:
a setting interface; and
an upper boundary decision circuit, coupled to the non-linear conversion circuit and the setting interface, and controlling the non-linear conversion circuit in accordance with the setting interface, so as to adjust a curve boundary of the third gain value.

26. The data gain regulating circuit as claimed in claim 23, further comprising:
a high dynamic range engine; and
an upper boundary decision circuit, coupled to the non-linear conversion circuit and the high dynamic range engine, wherein the upper boundary decision circuit controls the non-linear conversion circuit according to an operation result of the high dynamic range engine, so as to dynamically adjust a curve boundary of the third gain value.

27. The data gain regulating circuit as claimed in claim 16, further comprising at least one of following circuits:
a first debounce circuit, receiving the ambient light information, and clamping the ambient light information to a first variation range;
a second debounce circuit, receiving the backlight information, and clamping the backlight information to a second variation range; and
a re-mapping circuit, having a conversion relationship to re-map the ambient light information to a new ambient light value, and providing the new ambient light value to the gain decision circuit.

28. The data gain regulating circuit as claimed in claim 16, further comprising a backlight regulating circuit coupled to the gain decision circuit and controlling the gain decision circuit to correspondingly regulate the gain value of the display data according to the ambient light information and the backlight information.

29. The data gain regulating circuit as claimed in claim 28, wherein the backlight regulating circuit further outputs a backlight control signal according to the ambient light information and the backlight information, and the backlight control signal is configured to control a backlight module to dynamically regulate a backlight luminance.

30. The data gain regulating circuit as claimed in claim 28, wherein the backlight regulating circuit comprises:
a target backlight decision circuit, converting an original backlight value represented by the backlight information into a target backlight value according to the ambient light information and the backlight information, and the gain decision circuit regulates the gain value of the display data according to the target backlight value and the ambient light information.

31. The data gain regulating circuit as claimed in claim 30, wherein the backlight regulating circuit further comprises at least one of following circuits coupled between the target backlight decision circuit and the gain decision circuit:
a delay circuit, configured to delay a variation of the target backlight value; and
a smooth circuit, configured to smooth the variation of the target backlight value.

32. The data gain regulating circuit as claimed in claim 30, wherein the backlight regulating circuit further comprises;
a setting interface, coupled to the target backlight decision circuit for providing a human-machine interface, so as to facilitate a user regulating the target backlight value of the target backlight decision circuit.

33. The data gain regulating circuit as claimed in claim 28, wherein the data gain regulating circuit is adapted to operate in at least one of following gain decision modes:
a first gain decision mode: the backlight regulating circuit provides an original backlight value represented by the backlight information and the ambient light information to the gain decision circuit, and the gain decision circuit regulates the gain value according to the original backlight value and the ambient light information, wherein the original backlight value is non-related to the ambient light information; and
a second gain decision mode: the backlight regulating circuit first converts the original backlight value represented by the backlight information into a target backlight value according to the backlight information and the ambient light information, and provides the target backlight value and the ambient light information to the gain decision circuit, and the gain decision circuit regulates the gain value according to the target backlight value and the ambient light information, wherein the target backlight value is related to the ambient light information.

34. The data gain regulating circuit as claimed in claim 28, wherein the data gain regulating circuit is adapted to operate in at least one of following backlight control modes:
a first backlight control mode: the backlight regulating circuit provides a backlight control signal to the backlight module according to an original backlight value represented by the backlight information, wherein the backlight control signal is non-related to the ambient light information; and
a second backlight control mode: the backlight regulating circuit first converts an original backlight value represented by the backlight information into a target backlight value according to the backlight information and the ambient light information, and provides a backlight control signal to the backlight module according to the target backlight value, wherein the backlight control signal is related to the ambient light information.

35. A data gain regulating method, adapted to a display apparatus, comprising:
determining a gain value according to backlight information and ambient light information; and
receiving display data, and correspondingly regulating the display data according to the gain value to obtain regulated display data.

36. The data gain regulating method as claimed in claim 35, wherein the step of determining the gain value comprises determining the gain value according to the display data besides according to the ambient light information and the backlight information.

37. The data gain regulating method as claimed in claim 36, wherein the step of determining the gain value comprises first determining a “display data-gain relationship” according to the ambient light information and the backlight information, and obtaining the gain value from the determined “display data-gain relationship” according to the display data.

38. The data gain regulating method as claimed in claim 35, wherein when the ambient light information indicates that the display apparatus is in a strong ambient light environment, the gain value is correspondingly increased; and when the ambient light information indicates that the display apparatus is in a non-strong ambient light environment, the gain value is correspondingly decreased.
